(19) United States
(12) Patent Application Publication
(10) Pub. No.: US 2007/0289268 A1
(43) Pub. Date: Dec. 20, 2007

(54) Air filter assembly

(76) Inventor: Gordon R. Smith, Riddle, OR (US)

Correspondence Address: LAW OFFICE OF GERALD D. HAYNES, 2 NORTH OAKDALE ANENUE, MEDFORD, OR, 97501, US

(21) Appl. No.: 11/455,451

(22) Filed: Jun. 19, 2006

(51) Int. Cl. B01D 46/00

(52) U.S. Cl. 55/385.3

(57) ABSTRACT

An air filter assembly is disclosed. An illustrative embodiment of the air filter assembly includes a generally cylindrical air filter housing having a filter housing interior; a carburetor opening provided in the air filter housing and communicating with the filter housing interior; a first housing inlet arm and a second housing inlet arm carried by the air filter housing in spaced-apart relationship with respect to each other and communicating with the filter housing interior; a first air filter and a second air filter communicating with the first housing inlet arm and the second housing inlet arm, respectively; and an air flow deflector provided in the filter housing interior at generally a center of the air filter housing.

### FIELD

The present invention relates to automotive air filters. More particularly, the present invention relates to an automotive air filter assembly having an air flow deflector which condenses air as it flows from the air filter assembly into a carburetor.

### BACKGROUND

Internal combustion engines having carburetors include an air filter which is contained in an air filter housing that typically sits above the carburetor. Air flows into an inlet provided in the filter housing, through the air filter and then through an opening typically provided in the bottom of the filter housing, into the carburetor. Conventional stock air filters are typically not designed to modify flow of air from the air filter housing and into the carburetor in such a manner as to enhance performance of the engine. Therefore, a variety of after-market air filters have been designed which concentrate, render uniform or otherwise modify the flow characteristics of air as it flows from an air filter housing and into a carburetor in order to enhance the performance of an automobile.

### SUMMARY

The present invention is generally directed to an air filter assembly. An illustrative embodiment of the air filter assembly includes a generally cylindrical air filter housing having a filter housing interior; a carburetor opening provided in the air filter housing and communicating with the filter housing interior; a first housing inlet arm and a second housing inlet arm carried by the air filter housing in spaced-apart relationship with respect to each other and communicating with the filter housing interior; a first air filter and a second air filter communicating with the first housing inlet arm and the second housing inlet arm, respectively; and an air flow deflector provided in the filter housing interior at generally a center of the air filter housing.

### BRIEF DESCRIPTION OF THE DRAWINGS

The invention will now be described, by way of example, with reference to the accompanying drawings, in which:

FIG. 1 is a side view of an illustrative embodiment of the air filter assembly, provided on a carburetor and an internal combustion engine (shown in phantom);

FIG. 2 is a bottom view of a filter housing element of an illustrative embodiment of the air filter assembly;

FIG. 3 is a top view of a filter housing element of an illustrative embodiment of the air filter assembly;

FIG. 4 is a general vertical sectional view of an illustrative embodiment of the air filter assembly and a carburetor on which the air filter assembly is mounted, with the carburetor provided on an internal combustion engine (shown partially in section), more particularly illustrating a typical flow of air through the filter housing element of the air filter assembly and into a carburetor;

FIG. 5 is a general horizontal sectional view of an illustrative embodiment of the air filter assembly, more particularly illustrating a typical counterclockwise flow of air through the filter housing element of the air filter assembly; and

FIG. 6 is a horizontal sectional view of the filter housing element of an illustrative embodiment of the filter housing assembly, more particularly illustrating a typical angled position of a pair of housing inlet arms with respect to the filter housing interior of the air filter housing.

### DETAILED DESCRIPTION

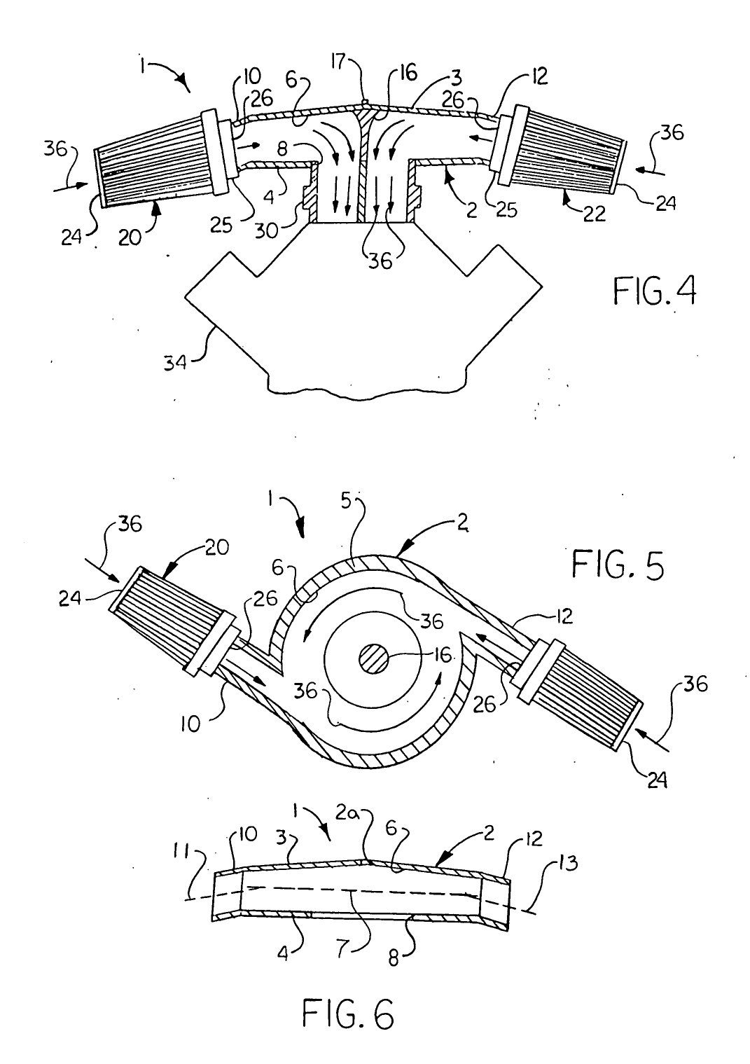

Referring to the drawings, an illustrative embodiment of the air filter assembly is generally indicated by reference numeral 1. As illustrated in FIG. 1 and will be hereinafter described, the air filter assembly 1 is designed to be mounted on a carburetor 30 (shown in phantom) of an internal combustion engine 34 (also shown in phantom), which carburetor 30 and internal combustion engine 34 may be conventional. The air filter assembly 1 receives and filters air 36 (FIG. 4) and concentrates the air 36 as the air 36 is distributed into the carburetor 30. This enhances performance of the internal combustion engine 34 as compared to the performance of internal combustion engines which are fitted with conventional air filter assemblies. Furthermore, the air 36 flows in a circular path through the air filter assembly 1, and this maintains cleanliness of the air filter assembly 1.

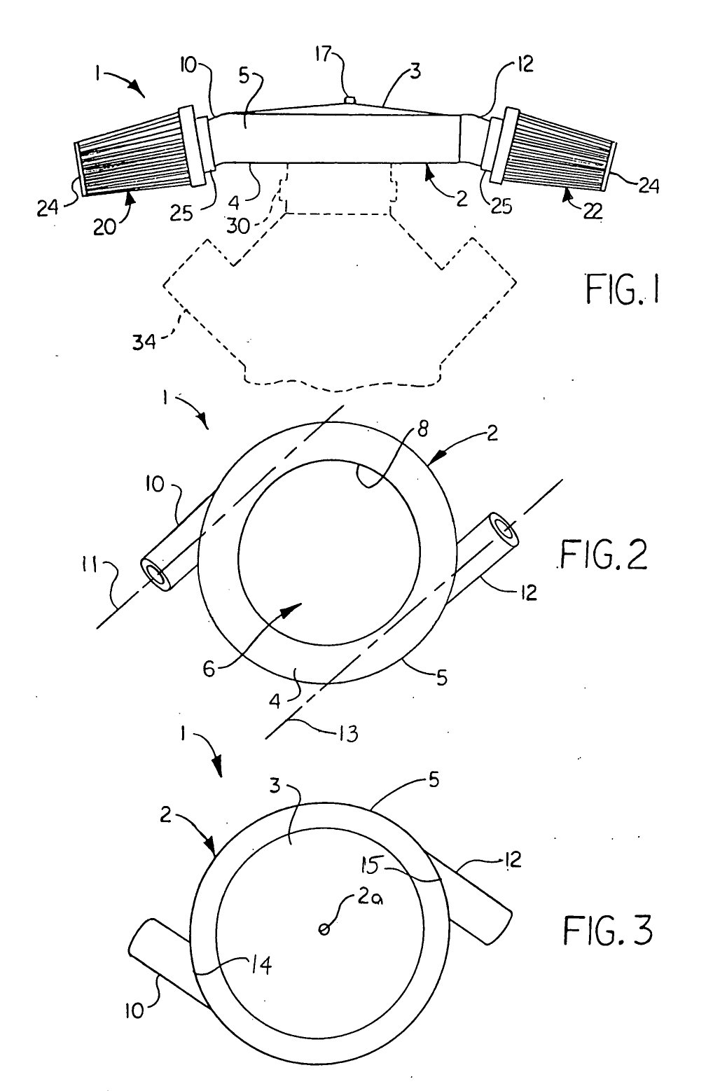

The air filter assembly 1 includes an air filter housing 2 having a side wall 5 that typically has a generally cylindrical configuration, as illustrated in FIGS. 2 and 3. An upper wall 3 which may be tapered and a lower wall 4 are provided on the side wall 5, in spaced-apart relationship to each other as shown in FIGS. 4 and 6. A filter housing interior 6 is defined by and between the side wall 5, the upper wall 3 and the lower wall 4 of the air filter housing 2.

As illustrated in FIG. 2, a carburetor opening 8 extends through the lower wall 4 and communicates with the filter housing interior 6 of the air filter housing 2. As illustrated in FIG. 6, a bolt opening 2a typically extends through the upper wall 3 and communicates with the filter housing interior 6. As illustrated in FIG. 4, an air flow deflector 16, the purpose of which will be hereinafter described, is provided in the filter housing interior 6, typically at substantially the center of the air filter housing 2. The air flow deflector 16 typically has an inverted cone shape and, in attachment of the air filter assembly 1 to the carburetor 30, is secured in the filter housing interior 6 typically by extending a bolt 17 through the bolt opening 2a (FIG. 6) in the upper wall 3 of the air filter housing 2 and through a registering bolt channel (not illustrated) which extends through the air flow deflector 16. The bolt 17 is threaded into an interiorly-threaded bolt opening (not illustrated) which extends into the housing of the carburetor 30 and registers with the bolt channel in the air flow deflector 16. Additional fasteners (not illustrated) may be used to secure the air filter housing 2 on the carburetor 30, according to the knowledge of those skilled in the art.

A housing inlet arm 10 and a housing inlet arm 12 extend from the air filter housing 2, in generally offset relationship with respect to each other and generally on opposite sides of the air filter housing 2. As illustrated in FIG. 5, the housing inlet arm 10 and the housing inlet arm 12 each communicates with the filter housing interior 6 of the air filter housing 2. The housing inlet arm 10 and housing inlet arm 12 may each have a generally elongated, cylindrical shape, typically having an arm axis 11 which extends through and is parallel with respect to the housing inlet arm 10 an arm axis 13 which extends through and is parallel with respect to the housing inlet arm 12. When the air filter housing 2 is viewed from below (FIG. 2) or from above (FIG. 3), the arm axis 11 of the housing inlet arm 10 is disposed in generally parallel, spaced-apart relationship with respect to the arm axis 13 of the housing inlet arm 12.

As illustrated in FIG. 6, a housing plane 7 extends through the air filter housing 2, in generally parallel relationship with respect to the lower wall 4 of the air filter housing 2. When the air filter housing 2 is viewed from the side, each of the arm axis 11 of the housing inlet arm 10 and the arm axis 13 of the housing inlet arm 12 is disposed at a generally obtuse angle with respect to the housing plane 7. In the functional configuration of the air filter assembly 1, in which the air filter housing 2 is mounted on the carburetor 30 (FIGS. 1 and 4), the arm axis 11 of the housing inlet arm 10 and the arm axis 13 of the housing inlet arm 12 extend generally downwardly with respect to the housing plane 7, as further illustrated in FIG. 6.

An air filter 20 is provided on the housing inlet arm 10 and an air filter 22 is provided on the housing inlet arm 12. The air filter 20 and the air filter 22 are disposed in fluid communication with the filter housing interior 6 of the air filter housing 2 through the housing inlet arm 10 and the housing inlet arm 12, respectively. The air filter 20 and the air filter 22 may each be a conventional, cone-shaped high-performance automotive air filter which is known by those skilled in the art, such as, for example, a K&N (trademark) high-performance automotive air filter. As illustrated in FIGS. 4 and 5, the air filter 20 and air filter 22 each includes a filter inlet 24 which is adapted to receive a stream of air 36. An attachment sleeve 25, having a filter outlet 26, receives the extending or distal end of the corresponding housing inlet arm 10 and housing inlet arm 12, respectively. The attachment sleeve 25 may be coupled to the corresponding housing inlet arm 10 or housing inlet arm 12 using a conventional clamp (not illustrated) or the like. Accordingly, in operation of the air filter assembly 1, which will be hereinafter described, the air 36 flows through the air filter 20 and air filter 22, respectively, and is thereby cleansed of particulate matter prior to flowing through the respective housing inlet arm 10 and housing inlet arm 12, respectively, and into the filter housing interior 6 of the air filter housing 2.

As shown in FIGS. 1 and 4, due to the angled positions of the housing inlet arm 10 and housing inlet arm 12 with respect to the air filter housing 2, the air filter 20 and air filter 22 assume a low profile when the air filter assembly 1 is mounted on the carburetor 30. This enables the air filter assembly 1 to fit inside an engine compartment (not illustrated) of an automobile in such a manner that the hood (not illustrated) of the engine compartment is capable of closing without interference by the air filter 20, air filter 22 or other element or elements of the air filter assembly 1.

In typical application of the air filter assembly 1, the air filter housing 2 is mounted on a carburetor 30 which is provided on an internal combustion engine 34, typically in the manner which was heretofore described. When the air filter housing 2 is mounted on the carburetor 30, as illustrated in FIG. 4, the fuel housing interior 6 of the air filter housing 2 communicates with the carburetor 30 through the carburetor opening 8 provided in the lower wall 4 of the air filter housing 2. The air filter 20 and the air filter 22 are attached to the housing inlet arm 10 and housing inlet arm 12, respectively. During operation of the internal combustion engine 34, air 36 is drawn into the filter inlet 24 of each air filter 20 and air filter 22; flows through the air filters 20, 22; exits the air filters 20, 22 through the respective filter outlets 26; flows through the housing inlet arm 10 and housing inlet arm 12, respectively; and enters the filter housing interior 6 of the air filter housing 2. As the air 36 passes through the air filters 20, 22, particulate matter is removed from the flowing air 36.

As illustrated in FIG. 5, due to the configuration of the housing inlet arms 10, 12 with respect to the air filter housing 2, the air 36 flows in a rotational path, such as a counterclockwise direction, for example, through the filter housing interior 6, initially adjacent to the side wall 5 of the air filter housing 2. This maintains the interior surfaces of the air filter housing 2 in a substantially particle-free condition as the flowing air 36 prevents the settling of particles onto the interior surfaces of the air filter housing 2.

As illustrated in FIG. 4, due to a drop in air pressure between the carburetor 30 and the filter housing interior 6, which drop in air pressure results from combustion of fuel inside the internal combustion engine 34, the air 36 gradually flows inwardly in a spiral path toward and then against the air flow deflector 16. Due to the inverted cone shape of the air flow deflector 16, the air 36 is deflected downwardly into the carburetor 30, as illustrated in FIG. 4. Consequently, the air flow deflector 16 concentrates the air 36 as the air 36 flows into the carburetor 30. This concentration of the air 36 as it flows into the carburetor 30 ensures an optimal air/fuel mixture for optimal performance of the internal combustion engine 34.

While the preferred embodiments of the invention have been described above, it will be recognized and understood that various modifications can be made in the invention and the appended claims are intended to cover all such modifications which may fall within the spirit and scope of the invention.

What is claimed is:

1. An air filter assembly, comprising:
a generally cylindrical air filter housing having a filter housing interior;
a carburetor opening provided in said air filter housing and communicating with said filter housing interior;
a first housing inlet arm and a second housing inlet arm carried by said air filter housing in spaced-apart relationship with respect to each other and communicating with said filter housing interior;
a first air filter and a second air filter communicating with said first housing inlet arm and said second housing inlet arm, respectively; and
an air flow deflector provided in said filter housing interior at generally a center of said air filter housing.

2. The air filter assembly of claim 1 wherein said air flow deflector has a generally inverted cone-shaped configuration.

3. The air filter assembly of claim 1 wherein each of said first housing inlet arm and said second housing inlet arm is disposed at a generally obtuse angle with respect to said air filter housing.

4. The air filter housing of claim 1 wherein said first air filter and said second air filter each comprises a filter inlet and a filter outlet spaced-apart from said filter inlet and communicating with said first housing inlet arm and said second housing inlet arm, respectively.

5. The air filter housing of claim 4 further comprising an attachment sleeve carried by each of said first air filter and said second air filter at said filter outlet.

6. The air filter housing of claim 1 wherein said first housing inlet arm and said second housing inlet arm are disposed in generally offset relationship with respect to each other on opposite sides of said air filter housing.

7. The air filter housing of claim 1 further comprising a bolt opening provided in said air filter housing and a bolt extending through said bolt opening and said air flow deflector.

8. The air filter housing of claim 1 wherein each of said first air filter and said second air filter is generally cone-shaped.

9. An air filter assembly, comprising:
an air filter housing having a generally cylindrical side wall, a first wall and a second wall carried by said side wall and a filter housing interior defined between said side wall, said first wall and said second wall;
a carburetor opening provided in said second wall of said air filter housing and communicating with said filter housing interior;
a first housing inlet arm and a second housing inlet arm extending from said side wall in spaced-apart relationship with respect to each other and communicating with said filter housing interior;
a first air filter and a second air filter communicating with said first housing inlet arm and said second housing inlet arm, respectively; and
an air flow deflector provided in said filter housing interior at generally a center of said upper wall of said air filter housing.

10. The air filter assembly of claim 9 wherein said air flow deflector has a generally inverted cone-shaped configuration.

11. The air filter assembly of claim 9 further comprising a first elongated arm axis and a second elongated arm axis extending in generally parallel relationship with respect to said first housing inlet arm and said second housing inlet arm, respectively, and a housing plane extending in generally parallel relationship with respect to said second wall of said air filter housing, and wherein each of said first arm axis and said second arm axis is disposed at a generally obtuse angle with respect to said housing plane.

12. The air filter housing of claim 9 wherein said first air filter and said second air filter each comprises a filter inlet and a filter outlet spaced-apart from said filter inlet and communicating with said first housing inlet arm and said second housing inlet arm, respectively.

13. The air filter housing of claim 12 further comprising an attachment sleeve carried by each of said first air filter and said second air filter at said filter outlet.

14. The air filter housing of claim 9 wherein said first housing inlet arm and said second housing inlet arm are disposed in generally offset relationship with respect to each other on opposite sides of said air filter housing.

15. The air filter housing of claim 9 further comprising a bolt opening provided in said first wall of said air filter housing and a bolt extending through said bolt opening and said air flow deflector.

16. The air filter housing of claim 9 wherein each of said first air filter and said second air filter is generally cone-shaped.

17. An air filter assembly, comprising:
an air filter housing having a generally cylindrical side wall, a first wall and a second wall carried by said side wall and a filter housing interior defined between said side wall, said first wall and said second wall;
wherein a housing plane extends through said air filter housing in generally parallel relationship with respect to said second wall;
a carburetor opening provided in said second wall of said air filter housing and communicating with said filter housing interior;
a generally elongated first housing inlet arm and a generally elongated second housing inlet arm extending from opposite sides of said side wall in generally offset relationship with respect to each other and communicating with said filter housing interior;
wherein a first arm axis extends through and in generally parallel relationship with respect to said first housing inlet arm and a second arm axis extends through and in generally parallel relationship with respect to said second housing inlet arm;
wherein said first arm axis and said second arm axis are disposed in generally parallel, spaced-apart relationship with respect to each other;
a first air filter and a second air filter communicating with said first housing inlet arm and said second housing inlet arm, respectively; and
an air flow deflector provided in said filter housing interior at generally a center of said upper wall of said air filter housing.

18. The air filter assembly of claim 17 wherein said air flow deflector has a generally inverted cone-shaped configuration.

19. The air filter assembly of claim 17 wherein each of said first arm axis and said second arm axis is disposed at a generally obtuse angle with respect to said housing plane.

20. The air filter housing of claim 17 wherein said first air filter and said second air filter each has a generally cone-shaped configuration and comprises a filter inlet and a filter outlet spaced-apart from said filter inlet and communicating with said first housing inlet arm and said second housing inlet arm, respectively.
